(19) United States
(12) Patent Application Publication
(10) Pub. No.: US 2002/0067543 A1
(43) Pub. Date: Jun. 6, 2002

(54) Viewing apparatus and method

(76) Inventors: Shinya Inoué, Falmouth, MA (US); Robert Allen Knudson, Mt. Vernon, ME (US)

Correspondence Address: Jason A. Reyes, Hale and Dorr LLP, 60 State Street, Boston, MA, 02109, US

(21) Appl. No.: 09/728,510

(22) Filed: Dec. 1, 2000

(51) Int. Cl. G02B 21/00; G02B 21/06; G02B 5/30; G02B 27/28

(52) U.S. Cl. 359/368; 359/371; 359/387; 359/494

(57) ABSTRACT

Optical apparatus includes a first material that causes positive birefringent retardation under physical strain and a second material that causes negative birefringent retardation under physical strain. The first and second materials are arranged along a common line of sight so that under physical strain the combination of the first and second materials causes birefringent retardation having a magnitude that is less than the magnitude of the positive retardation caused by the first material and that is less than the magnitude of the negative retardation caused by the second material.

### BACKGROUND OF THE INVENTION

This application relates to viewing a subject under physical stress or strain.

A transparent material may be used in a container, such as a specimen chamber, to allow the container's contents to be viewed from outside, or may be used in a protective surface on a device such as an optical data disc such as a DVD or CD-ROM disc to help prevent damage to an information bearing surface of the disc.

An object that includes a transparent material may encounter physical stress. Such stress can occur with specimen chambers under high centrifugal forces, cover plates for optical data discs rotating at high speeds, and vehicle windows that are subjected to high atmospheric-or hydrostatic-pressure differences.

The optical properties of a transparent material may be affected by physical stress acting on the material. For example, birefringence may be induced or increased as a result of the stress. The birefringence caused by the stress can interfere with the proper functioning of the transparent material. In particular, the stress can affect measurements that are based on birefringence. For example, living cells and other quasi-fluid specimens may be examined in a specimen chamber under centrifugal force in a centrifuge microscope. In such a case, molecules and fine structures of the specimen become aligned and birefringent as a result of force-induced stratification of components of different density in the specimen, which allows analytic observations of the specimen to be made based on such birefringence. However, when birefringence introduced into the windows of the chamber by the high centrifugal force becomes significant relative to the birefringence of the specimen itself, it becomes difficult or impossible to rely on birefringence in determining accurately the alignment of molecules and fine structures produced by the centrifugation.

An optical data disc is typically read by modulating a beam of polarized light directed to an information bearing surface of the disc. At the high rotational speeds that are typically used, the cover plates and supporting media of the discs can become excessively birefringent as a result of centrifugal forces, and thereby interfere with accurate reading of the disc.

A window on a high altitude or deep submersible vehicle can encounter many atmospheres of pressure differential, which can increase birefringence in the window. The birefringence retardation induced in the window can amount to several wavelengths of visible light. As a result, in the case of incident light that is polarized (naturally or by intent), the window can appear colored or develop patchy transmission from the perspective of an observer in the vehicle wearing polarized eyeglasses. The increased birefringence may interfere with normal viewing even for an observer not wearing polarized eyeglasses, since light that is reflected from surfaces, or is scattered by the atmosphere, or is refracted at an air-water interface, can thereby become polarized, and the inner surface of the window itself can act as a second polarizer, or analyzer, at some angles of view.

Some materials, such as Pockel's glass, have been described as exhibiting little or no increased birefringence under physical strain, but such materials have been found to be difficult to obtain for practical applications and have been recognized as possessing undesirable physical, chemical, or biological attributes. Pockel's glass is a flint type of glass having a lead oxide content of approximately 75%. As is generally known, as the lead content of glass is increased, the coefficient of stress birefringence decreases, and beyond a lead content of about 70% to 80%, the sign of birefringence reverses. In the reversal, the refractive index for the E-vector becomes greater for the birefringent component along the direction of compression than for the component at right angles to it. Pockel's glass has been found to exhibit little or no stress birefringence, as described in Ann. der Physik, Ser. IV, Vol. VII, pp. 745 et seq.; Coker, E. G., and L. N. G. Phylon, 1931, A Treatise on Photo-elasticity, Cambridge University Press, pp. 215-220. Disadvantages of Pockel's glass include its tendency to leach lead, which can be toxic, and to weather poorly.

### SUMMARY OF THE INVENTION

Apparatus is provided to reduce or eliminate an effect of stress-induced or stress-increased birefringence in transparent materials. In a specific embodiment, a device is provided that includes two or more components having differing and opposing birefringent responses to physical strain such that the responses substantially cancel each other out, rendering the overall device effectively immune from increased birefringence due to the physical strain.

In accordance with the invention, a specimen chamber can be provided having a window that exhibits little or no increased birefringence in response to physical strain. In particular, a thin glass plate can be combined with a thicker sheet of well-annealed acrylic. In the acrylic sheet, the coefficient of strain birefringence is less than that for glass (i.e., less birefringence is induced per unit stress), and is opposite in sign. Under centrifugal strain, the glass plate becomes birefringent, with the slower component of the light wave (i.e., the E-vector of the wave suffering greater refraction due to the birefringence) oscillating in a plane perpendicular to the direction of compression due to the strain. In the acrylic sheet, the slower component oscillates parallel to the direction of compression. Accordingly, depending on the particular thicknesses of the glass plate and the acrylic sheet, the strain induced birefringent effect produced by the glass plate is substantially offset by the strain induced birefringent effect produced by the acrylic plate, so that little or no increase in birefringence develops in the overall combination under strain.

Other features and advantages will become apparent from the following description, including the drawings, and from the claims.

### BRIEF DESCRIPTION OF THE DRAWINGS

FIGS. 1 and 3 are illustrations of centrifuge microscope apparatus.

FIG. 2 is an illustration of pulse laser timing of centrifuge microscope apparatus.

FIGS. 4A-4B, 5A-5B, 6A-6B, and 7 are illustrations of portions of centrifuge microscope apparatus.

FIG. 8 is an illustration of birefringence results produced by centrifuge microscope apparatus.

FIGS. 9-13B are illustrations of birefringence resistant apparatus.

### DETAILED DESCRIPTION

Centrifuge microscopes are described in U.S. Pat. Nos. 5,982,535 and 5,930,033, which are incorporated herein by reference. A sample chamber 500 described below has characteristics, including birefringence resistant characteristics, that may be applied to sample chamber 81 of such centrifuge microscopes.

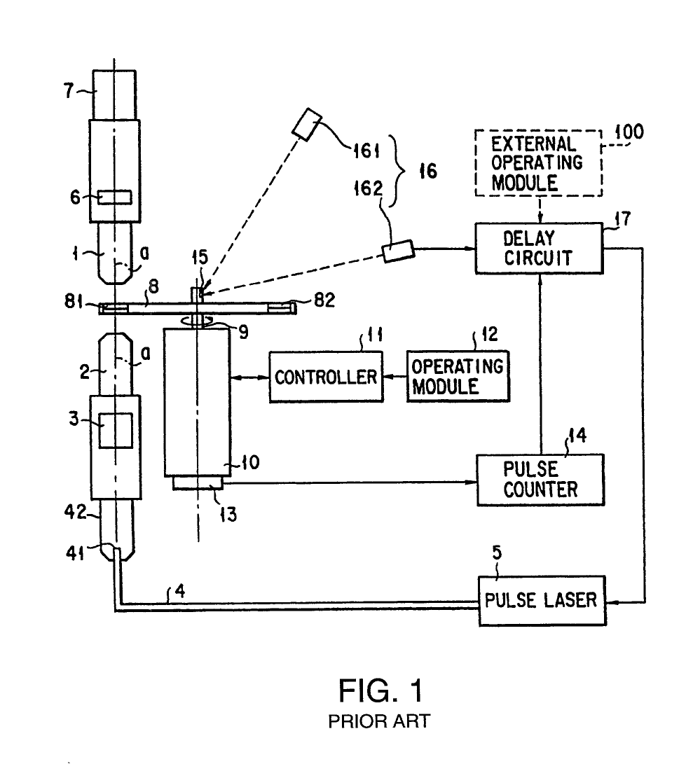

FIG. 1 illustrates a centrifuge microscope that includes an optical system for observation of transmission polarized light. An objective lens 1 and a condenser lens 2 are arranged so that the optical axis of lens 1 is coincident with the optical axis of lens 2. On the optical axis (a) of the condenser lens 2 are a polarizer 3, a beam expander 42, and a light output end 41 of an optical fiber 4. The other end of fiber 4 is connected to a pulse laser 5. An analyzer 6 and a CCD or other video or photographic camera 7 are arranged on the optical axis (a) of the objective lens 1.

In a specific implementation, pulse laser 5 has a short pulse width and little jitter and is capable of a high output. Laser 5 may include one or more of the following: a Neodymium (“Nd”): yttrium-aluminum-garnet/yttrium-lithium-fluoride (“YAG/YLF”) laser, a Nd:potassium-gadolinium-tungstate (“KGW”) chamber laser, an Nd:glass laser, a nitrogen/dye laser, a dye laser, and a wavelength changeable solid state laser.

A disk 8 is arranged in a space between the objective lens 1 and the condenser lens 2. The disk 8 is supported by a stable rotation axis mechanism 9 and is driven by a motor 10 such as an air spindle through rotation axis mechanism 9. A sample chamber 81 (also known as “specimen chamber”) for accommodating a sample (not shown) is provided at a peripheral portion of the disk 8. The sample chamber 81 comes across (i.e., intersects) the optical axis (a) between the objective lens 1 and the condenser lens 2 in accordance with the rotation of the disk 8. Disk 8 may also be provided with a dummy sample chamber 82 at the opposite end of the sample chamber 81 in the peripheral portion with respect to the center of rotation, i.e., the rotation axis 9. The rotational stability of disk 8 at high speeds is enhanced by sample chambers 81 and 82 being disposed on disk 8 substantially symmetrically with respect to the center of rotation.

A controller 11 is connected to motor 10 for driving disk 8. The controller 11 can change the rotational speed of the motor 10 according to the instruction of the user through an operating module 12. Motor 10 is provided with an encoder 13, which is connected to a pulse counter 14. The encoder 13 generates a rectangular wave each time the motor 10 is oriented at a predetermined angle. The pulse counter 14 receives the rectangular wave output from the encoder 13, calculates the rotational speed of the disk 8 by counting the number of the rectangular waves, and adjusts the delay amount of a delay circuit 17 based on the calculation result.

A mirror 15 is provided at the edge of rotation axis 9 that supports disk 8, with the mirror surface arranged towards a known direction. The mirror 15 can be placed on any portion of rotation axis 9 or disk 8. A position detection portion 16 including a laser diode (“LD”) 161 and a photo detector (“PD”) 162 is arranged in correspondence with mirror 15. The position detecting portion 16 directs a laser beam from the laser diode 161 to mirror 15 and receives a reflected light from mirror 15 at a photo detector 162. Photo detector 162 receives reflected light from the mirror 15 whenever the disk 8 takes on a particular orientation, so as to generate a pulse to indicate the occurrence of the particular orientation, and to provide output to the delay circuit 17 when the sample chamber 81 of the rotating disk 8 passes across the optical axis.

The photo detector 162 is connected to the delay circuit 17 that generates a signal for indicating a delay time, later described, at a certain time after receiving a pulse output from the photo detector 162, and produces a signal to the pulse laser 5 as the trigger signal for emitting the pulse laser. The delay circuit 17 can adjust the length of the delay time based on a signal received from the pulse counter 14.

As the pulse width of a laser beam generated from the pulse laser 5 widens, an observed image farther from the optical axis (a) is picked up by the CCD camera, which causes the observed image to blur and the resolution to deteriorate. Therefore, by setting the pulse width appropriately with respect to the resolution of the objective lens 1 as mentioned below, a high resolving power is obtained in the observation system. The following concepts are referenced below:

numerical aperture of the objective lens: NA

laser wavelength: λ (μm)

laser pulse width: h (nsec)

rotation radius of the sample: R (mm)

maximum rotation speed of the sample: N (rpm),

The resolution Δ of the objective lens 1 can be represented by the following formula (1) in accordance with Rayleigh's formula:

Δ=0.61×λ/NA (1)

The blurring of the observed image according to the emission period of the laser beam is represented by the following formula (2):

(rotation speed of the sample)×(laser emission period)=(rotation speed of the sample)×(pulse width)

=(2πR×10³×N/60)×h/10⁹

=(2πR×N/60)×h)1000000(μm).

Where the blurring of the observed image is reduced to a level that is undetectable at the resolution of the objective lens 1, the resolution of the observation system is not deteriorated, and the pulse width of a laser beam generated from the pulse laser 5 is set in a range that satisfies the following formula (3):

h≦(0.61×λ/NA)/((2πR×N/60)/1000000) (3)

The user places a sample to be observed in sample chamber 81 in disk 8 and sets the rotation speed of the motor 10 through the operating module 12. The controller 11 drives the motor 10 according to the rotation speed, and the motor 10 rotates disk 8 around rotation axis 9 at the rotation speed. A laser beam is emitted from pulse laser 5 at the time sample chamber 81 of disk 8 comes across optical axis (a) between objective lens 1 and condenser lens 2. The laser beam reaches polarizer 3 from optical fiber 4 so as to be polarized by polarizer 3 and passes through the sample in sample chamber 81 via condenser lens 2. Furthermore, the laser beam transmitted by the sample reaches CCD camera 7 through analyzer 6 via objective lens 1. Accordingly, the observed polarized light image of the sample is picked up by CCD camera 7.

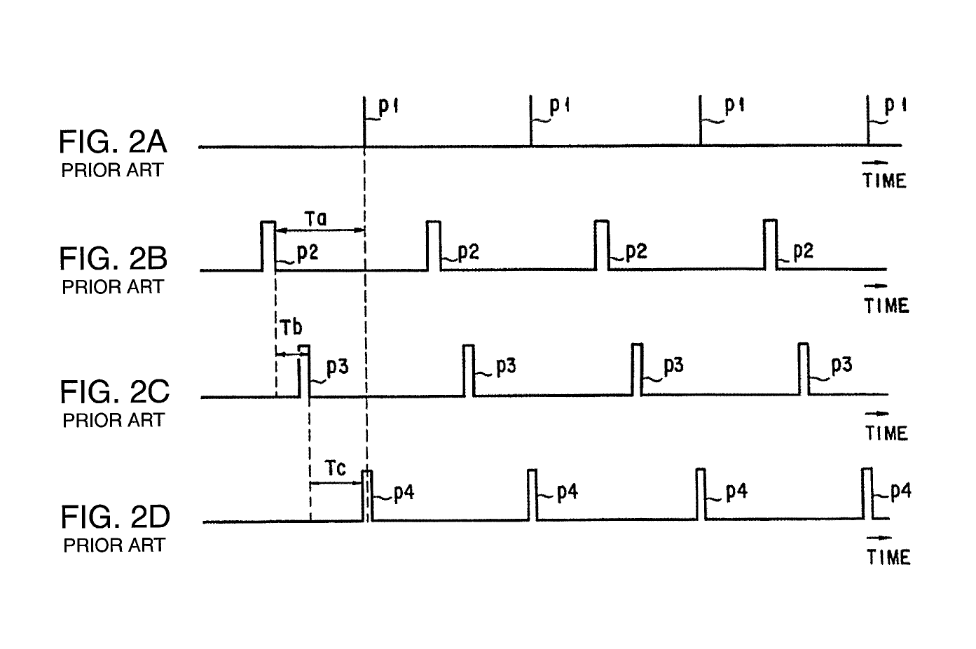

FIGS. 2A-2D are diagrams explaining the laser emission timing of the pulse laser 5 of FIG. 1. FIG. 2A describes the timing involved with respect to the sample chamber 81 of disk 8 coming across the optical axis (a) at a desired time point p1. In accordance with the timing shown in FIG. 2B, a pulse p2 is produced by the photo detector 162 of the position detecting portion 16. In this case, in the position detecting portion 16, a laser beam is directed from the laser diode 161 to the mirror 15 which is arranged facing a particular direction out from the rotation axis 9 that supports the disk 8. After the photo detector 162 receives reflected light from the mirror 15, a pulse is produced by the photo detector 162 that is out of phase but otherwise synchronized with the timing at which the sample chamber 81 passes the optical axis (a).

The delay circuit 17 receives the pulse p2 produced by the photo detector 162. As shown in FIG. 2C, the delay circuit 17 produces a pulse p3 that is delayed with respect to the pulse p2 by a time Tb, as the trigger signal for the pulse laser 5. The delay time Tb is determined by an intrinsic delay time preliminarily set in the delay circuit 17 and the delay amount appropriate to the rotation speed of the disk 8 as measured by the pulse counter 14.

After receiving the trigger signal p3, the pulse laser 5 emits a laser beam as shown in FIG. 2D at the timing shown by a pulse p4, after an interval of time Tc passes from receipt the trigger signal. The time interval Tc is the time needed for the laser emission from the pulse laser 5, and thus is constant regardless of the rotational speed of the disk 8.

As a result, after the time Ta passes from the production of the pulse p2, a laser beam is emitted from the pulse laser 5 with the timing being synchronized with the sample chamber 81 coming across the optical axis (a) between the objective lens 1 and the condenser lens 2, i.e., with the timing represented by the time point p1. In particular, a laser beam is emitted from the pulse laser 5 delayed by the time Ta from the pulse produced by the photo detector 162 for per every rotation of the disk 8. Thus, the timing of the laser emission from the pulse laser 5 is coincident with the timing of the sample chamber 81 coming across the optical axis (a) between the objective lens 1 and the condenser lens 2.

The time Ta becomes shorter as the rotation speed of the disk becomes faster, and becomes longer as the rotation speed becomes slower. Therefore, for example, if the disk 8 rotates at 1000 rpm, and the sample chamber 81 passing the optical axis (a) between the objective lens 1 and the condenser lens 2 coincides with the laser beam emission from the pulse laser 5, such coincidence would break down if the rotation of the disk 8 were increased in speed to 1200 rpm or more, and the value of the time Ta remained the same.

However, since the rectangular wave produced by the encoder 13 present in the motor 10 changes when the rotational speed of the disk 8 changes, the delay amount of the delay circuit 17 is adjusted at the pulse counter 14 based on the rotation speed of the disk 8 as indicated by the encoder 13. Accordingly, the delay time Tb of the delay circuit 17 is changed so that the laser beam emission from the pulse laser 5 continues to coincide with the sample chamber 81 passing the optical axis (a) between the objective lens 1 and the condenser lens 2.

The laser pulse width from the pulse laser 5 derived from the formula (3) described above gives rise to the following formula (4) in a specific example as follows:

numerical aperture of the objective lens: NA=0.4(20 times)

laser wavelength: Δ=0.532 (μm)

rotation radius of the sample: R=80 (mm)

maximum rotation speed of the sample: N=12000 (rpm)

h≦(0.61×λ/NA)/((2πR×N/60)/1000000)=8.1

Accordingly, a pulse laser 5 with the pulse width h=5 [nsec] needs to be used. In this case, the resolution Δ of the objective lens 1 can be represented by the following formula (5):

Δ=0.61×λ/NA=0.81 (μm) (5)

The amount of the sample's movement during the laser emission period (i.e., exposure time) is determined by the pulse width. In particular, the blurring of the observed image s may be represented by the following formula (6):

(rotation speed of the sample)×(laser emission period)=((2πR×N/60/1000000)×h=0.5 (μm) (6)

Accordingly, in an appropriately configured system, the observed images are not excessively blurred, and microscope observation can be conducted without excessive deterioration of the resolution of the observation system.

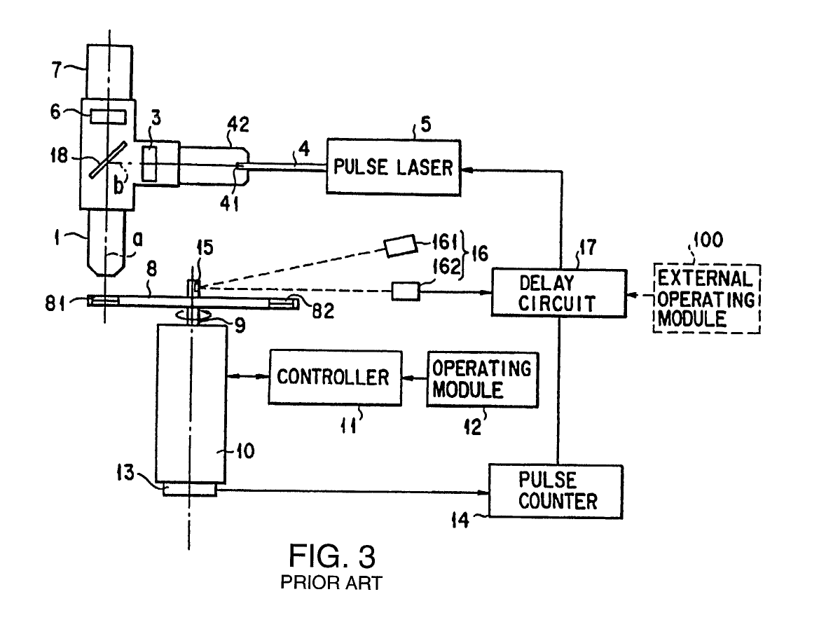

FIGS. 3, 4A-4B, 5A-5B, and 6A-6B illustrate various configurations of the centrifuge microscope.

FIG. 3 illustrates a configuration of the centrifuge microscope equipped with an optical system for incident-light polarized light observation. In FIG. 3, the same numerals are used for the portions that are the same as in FIG. 1.

As shown in FIG. 3, a half mirror 18 and an analyzer 6 are provided for incident-light illumination on the optical axis (a) of the objective lens 1. The half mirror 18, the polarizer 3, the beam expander 42, and the light outputting end 41 of the optical fiber 4 are arranged on the optical axis (b), which is orthogonal to the optical axis (a). The other end of the optical fiber 4 is connected to the pulse laser 5. As a result, an optical system for incident polarized light observation is provided.

As described above, the disk 8 is arranged below the objective lens 1, and the sample chamber 81 crosses the optical axis (a) of the objective lens 1 according to the rotation of the disk 8. At the time the sample chamber 81 passes the optical axis (a) of the objective lens 1, the pulse laser 5 emits a laser beam along the optical axis (b) in the direction of the polarizer 3 and the half mirror 18, i.e., toward the optical system for incident polarized light observation. The half mirror 18 may be replaced by double mirrors or a prism. The remaining configuration and operation of the centrifuge microscope are the same as those mentioned with reference to FIG. 1 and FIG. 2A-2D.

As described above, since the delay time Tb of the delay circuit 17 changes with the change of the rotation speed of the disk 8, the emission timing of the pulse laser 5 can be adjusted and the emission from the pulse laser 5 can be made coincident with the sample chamber 81 passing the optical axis (a) between the objective lens 1 and the condenser lens 2 in the transmission polarized light observation system, or passing the optical axis (a) of the objective lens 1 in the incident polarized light observation system. Therefore, the microscope observation can be conducted at a desired disk 8 rotation speed of the sample to provide a desired centrifugal force or changing centrifugal force to be applied to the sample. Further, by setting the pulse width h of the pulse laser 5 according to the resolution of the objective lens 1 consistent with the above-mentioned formulas, the microscope observation can be conducted without excessively deteriorating the resolution of the observation system.

According to the centrifuge microscopes of the specific embodiments, since pulse laser 5 is capable of providing a pulse width sufficiently short as the pulse emission light source, a polarized light observation system including polarizer 3 and analyzer 6 (specifically, a transmission polarized light observation system and an incident-light polarized light observation system) is achieved. Therefore, in the study of cell division, a highly effective polarized light observation can be taken based on birefringence differences. For example, a weakly birefringent sample of spindles is otherwise obscured by the highly birefringent yolk of the egg cells. Since the heavy yolk granules are displace by centrifugation, and pulse laser 5 provides a high output, a sufficient amount of light is provided for the polarized light microscope observation of the spindle.

In particular, a mitotic spindle that is surrounded by yolk granules in the egg cell may be observed as the specimen, by using the centrifuge microscope for observing the specimen while applying centrifugal force. In such a case, the separation state of the yolk can be confirmed and separation of the yolk can be achieved by controlling the rotation speed of the disk, so as to improve the percentage yield of spindles free of yolk granules. In addition, polarized light observation of the concentration and the molecular orientation of the microtubules that make up the spindle fibers or of the interacting force between the chromosomes and the microtubules can be achieved under high centrifugal force with high sensitivity and at high optical resolution. Furthermore, from polarized light observation of the spindles separated from yolk while changing the rotational speed of disk 8, the force applied to the spindle or chromosomes at the time of cell division can be quantified. Moreover, the molecular orientation and the fine structure of various colloid type industrial materials such as liquid crystals and emulsions under centrifugal field can be examined.

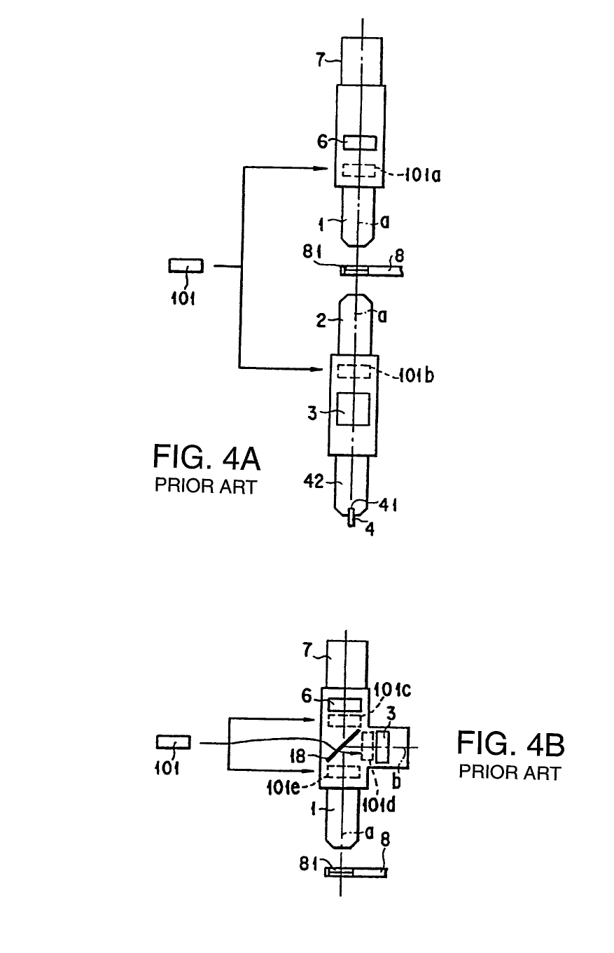

FIG. 4A illustrates the main portion of another configuration of the centrifuge microscope equipped with an optical system for transmission polarized light observation. The configuration of the centrifuge microscope includes compensators in addition to the configuration shown in FIG. 1. The portions other than the portion shown in FIG. 4A are the same as those of FIG. 1, and are not illustrated in FIG. 4A. In FIG. 4A, the same numerals are provided for the portions that are the same as in FIG. 1.

As shown in FIG. 4A, a compensator 101 is inserted between the polarizer 3 and the analyzer 6. In this case, one compensator 101 is provided between the analyzer 6 and the objective lens 1 (shown as 101a), or is provided between the polarizer 3 and the condenser lens 2 (shown as 101b). Or two compensators 101 may be inserted as both 101a and 101b.

FIG. 4B illustrates the main portion of another configuration of the centrifuge microscope equipped with an optical system for incident polarized light observation. The configuration of the centrifuge microscope includes compensators in addition to the configuration shown in FIG. 3. The portions other than the portion shown in FIG. 4B are the same as those of FIG. 3, and are not illustrated in FIG. 4B. In FIG. 4B, the same numerals are provided for the portions that are the same as in FIG. 3.

As shown in FIG. 4B, one compensator 101 is provided between the analyzer 6 and the half mirror 18 (shown as 101c), or between the polarizer 3 and the half mirror 18 (shown as 101d), or between the objective lens 1 and the half mirror 18 (shown as 101e). In other embodiments, two compensators 101 are inserted as any two of items 101c, 101d and 101e, or three compensators 101 are inserted as items 101c, 101d and 101e. In at least some cases, one to three compensators 101 can be inserted.

The compensators 101 inserted in the transmission polarized light observation system or the incident polarized light observation system allow emphasis of the contrast in the observation of a fine birefringence tissue, and measurement of an anisotropic body, as well as retardance measurements of a crystal, a fiber, an organism's tissue or of the birefringence induced by distortion.

A compensator is a birefringent phase plate capable of changing the retardation, and thus can be used for the measurement of the retardation. A precise measurement of the retardation of the sample can be achieved by offsetting the retardation generated in the sample by the compensator and reading out the calibrated compensator value.

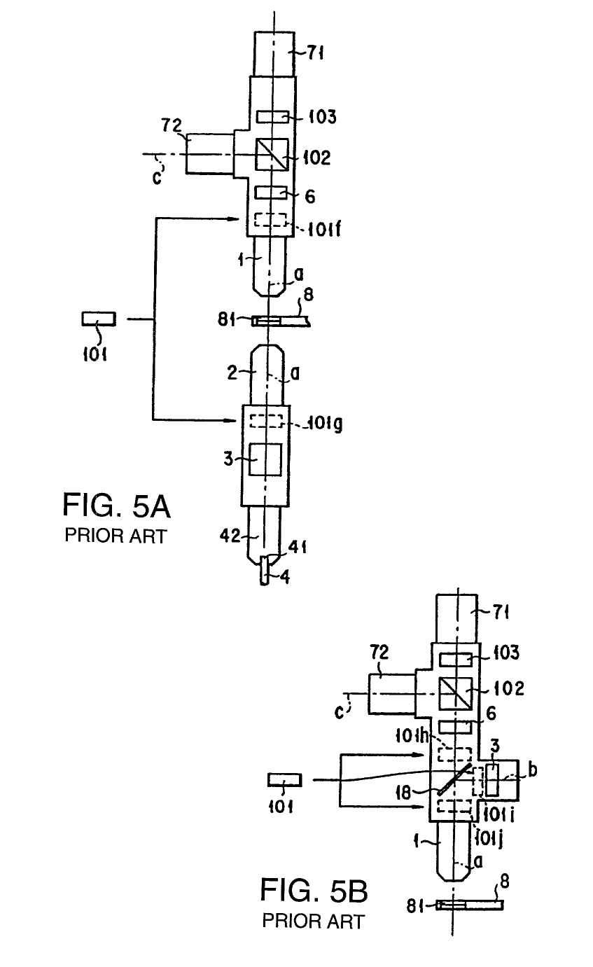

FIG. 5A illustrates the main portion of another configuration of the centrifuge microscope equipped with an optical system for transmission observation. The centrifuge microscope is able to conduct polarized light observation and fluorescence observation at the same time. The portions other than the portion shown in FIG. 5A are the same as those of FIG. 1, and are not illustrated in FIG. 5A. In FIG. 5A, the same numerals are provided for the portions that are the same as in FIG. 1.

As shown in FIG. 5A, an analyzer 6, a dichroic mirror 102, a barrier filter 103 and a CCD camera 71 for picking up the fluorescent image are arranged on the optical axis (a) of the objective lens 1. Furthermore, a CCD camera 72 for picking up the image observed in polarized light is provided on the optical axis (c) orthogonal to the optical axis (a).

Simultaneous observation in polarized light and by fluorescence excitation can be realized by arranging a dichroic mirror 102 between the objective lens 1 and the CCD cameras 71, 72, which are the image pick-up elements as mentioned above. The dichroic mirror is a mirror that reflects light of a certain wavelength (for polarized light observation) and transmits light of another wavelength (for fluorescence observation). The barrier filter is a filter that filters out light of excitation wavelengths from the light source, and selectively transmits the fluorescent image generated by the sample.

Major purposes for conducting polarized light observation include the revelation of molecular orientation and the density of oriented molecules. Accordingly, for example, in the division phase of live cells, one can observe movements of the mitotic spindles and its centrosomes, or polymerization and depolymerization of the microtubules that dynamically change with time, or the density of microtubules in the spindle fibers.

In the fluorescence mode, by using a fluorescent dye label, one can differentially label protein, nucleic acid, sugar, lipid, toxins, so that lipid film, cytoplasmic contents, or nucleic acid can be selectively visualized. Specific fluorescent proteins, fluorescence changes associated with enzyme substrate interactions, or fluorescent latex beads can be incorporated as well.

By fluorescence observations, one can measure calcium concentrations in the cell, membrane potentials, observe shape changes of nucleus and chromosomes, determine composition of DNA, measure enzyme activity, or visualize protein molecules of nm dimensions. Conducting the above-mentioned polarized light observation and fluorescence observation at the same time allows characteristics of molecules in a living body, such as a response reaction with respect to an input signal, to be clarified.

It is also possible to insert the compensator 101 between the polarizer 3 and the analyzer 6 as shown in FIG. 5A. In this case, one compensator 101 is provided between the analyzer 6 and the objective lens 1 (shown as 101f), or is provided between the polarizer 3 and the condenser lens 2 (shown as 101g), or two compensators 101 are inserted at both 101f and 101g.

FIG. 5B illustrates the main portion of another configuration of the centrifuge microscope equipped with an optical system for incident polarized light observation. The configuration of the centrifuge microscope enables polarized light observation and fluorescence observation at the same time. The portions other than the portion shown in FIG. 5B are the same as those of FIG. 3, and are not illustrated in FIG. 5B. In FIG. 5B, the same numerals are provided for the portions that are the same as in FIGS. 3 and 5A.

As shown in FIG. 5B, a half mirror 18, an analyzer 6, a dichroic mirror 102, a barrier filter 103, and a CCD camera 71 for picking up a fluorescent observed image are arranged on the optical axis (a) of the objective lens 1. A CCD camera 72 for picking up the image observed in polarized light is provided on the optical axis (c) orthogonal to the optical axis (a). Moreover, the half mirror 18, a polarizer 3, and a pulse laser 5 are provided on an optical axis (b) orthogonal to the optical axis (a).

As illustrated in FIG. 5B, compensators can be provided as now described. One compensator 101 is provided between the analyzer 6 and the half mirror 18 (shown as 101h), or between the polarizer 3 and the half mirror 18 (shown as 101i), or between the objective lens 1 and the half mirror 18 (shown as 101j). Or two compensators 101 are inserted as either two of 101h, 101i, and 101j. Or three compensators 101 are inserted as 101h, 101i, and 101j. In at least some cases, one to three compensators 101 can be inserted.

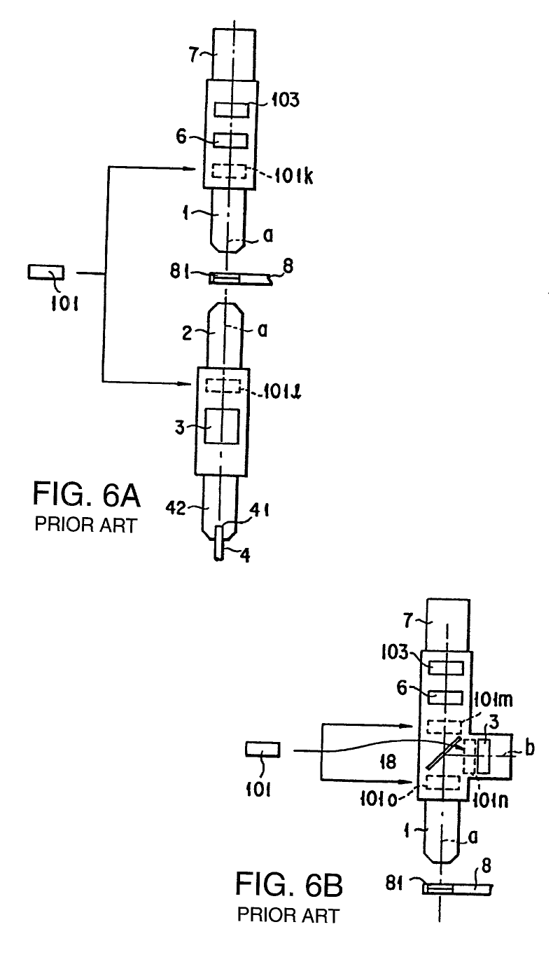

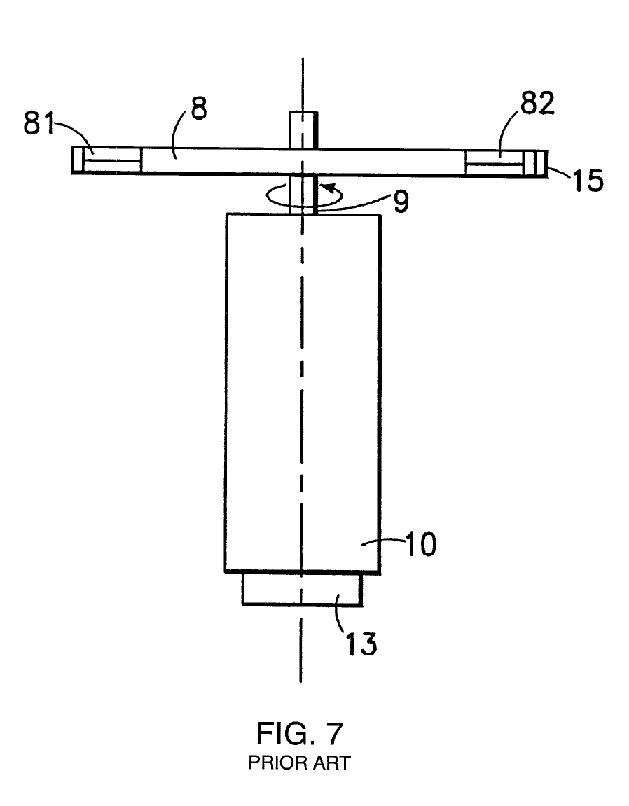

FIG. 6A illustrates the main portion of a configuration of the centrifuge microscope equipped with an optical system for transmitted light observation. So equipped, the centrifuge microscope enables polarized fluorescence observations. The portions other than the portion shown in FIG. 6A are the same as those of FIG. 1, and are not illustrated in FIG. 6A. In FIG. 6A, the same numerals are provided for the same portions as in FIG. 1.

As shown in FIG. 6A, an analyzer 6, a barrier filter 103 and a CCD camera 7 for picking up the polarized fluorescence image are arranged on the optical axis (a) of the objective lens 1. The polarized fluorescence observation can be realized by arranging the barrier filter 103 between the objective lens 1 and the CCD camera 7, which is the image pick-up element as mentioned above. By the polarized fluorescence observation method, the orientation of fluorescent molecules can be observed. That is, the behavior of the fluorescently tagged molecule can be observed and thus the application range of the centrifuge microscope can be widened. If the orientation of the same molecule is observed twice over a time interval, the rotational movement of the molecule can be observed. In this way, various important information such as the size of the molecule and the interaction among the molecules can be obtained.

With respect to FIG. 6A, it is also possible to insert a compensator 101 between the polarizer 3 and the analyzer 6. In this case, one compensator 101 is provided between the analyzer 6 and the objective lens 1 (shown as 101k), or is provided between the polarizer 3 and the condenser lens 2 (shown as 101l). Or two compensators 101 are inserted at both 101k and 101l.

FIG. 6B illustrates the main portion of another configuration of the centrifuge microscope equipped with an optical system for incident polarized light observation. So equipped, the centrifuge microscope enables observation of polarized fluorescence. The portions other than the portion shown in FIG. 6B are the same as those of FIG. 3, and are not illustrated in FIG. 6B. In FIG. 6B, the same numerals are provided for the portions that are the same as in FIGS. 3 and 6A.

As shown in FIG. 6B, a half mirror 18, an analyzer 6, a barrier filter 103 and a CCD camera 7 for picking up the fluorescence image are arranged on the optical axis (a) of the objective lens 1. The half mirror 18, a polarizer 3, and a pulse laser 5 are provided on the optical axis (b) orthogonal to the optical axis (a).

As illustrated in FIG. 6B, compensators can be provided as now described. One compensator 101 is provided between the analyzer 6 and the half mirror 18 (shown as 101m), or between the polarizer 3 and the half mirror 18 (shown as 101n), or between the objective lens 1 and the half mirror 18 (shown as 101o). Or two compensators 101 are inserted as either two of 101m, 101n, and 101o. Or three compensators 101 are inserted as 101m, 101n, and 101o. That is, one to three compensators 101 can be inserted.

Since a high power light source, namely, a pulse laser, is used in the centrifuge microscope of the present invention, not only can the simultaneous observation of the polarized light image, the fluorescence image, and the polarized fluorescence observation be realized, but also simultaneous observation of the polarized light observation and phase contrast observation, or polarized light observation method in combination with microscopy such as differential interference.

With reference to FIG. 1, as described above, the position of the sample chamber 81 may be detected by illuminating a laser beam from the laser diode 161 to the mirror 15 and receiving the light reflected from the mirror 15 at the photo detector 162 in the position detecting portion 16. Other methods such as detecting the position of the sample chamber 81 by providing a transmission aperture at a selected position of the disk 8, directing a laser beam to the transmission aperture, and detecting the transmitted laser beam, can be used.

Scanning of or focusing on the sample can be conducted by moving the sample mechanically or electrically with respect to the optical axis (a) of the objective lens 1, or by moving the microscope mechanically or electrically.

Mechanical movement of the sample with respect to the optical axis of the objective lens 1 can be achieved by moving the image forming system including the objective lens 1 and the CCD camera 7, and the illumination system including the condenser lens 2 and the beam expander 42, together by a driving device (not shown) with the location of the motor 10 being fixed. It is also possible to place the optical system on an XYZ stage independent from the motor and moving the XYZ stage by a driving device so as to allow scanning or focusing of the sample freely. It is also possible to move the motor 10, the rotation axis 9, and the disk 8 by a driving device (not shown), with the image forming system and the illumination system being fixed. In a specific example, the XYZ stage includes three sets of solid steel posts and sleeve roller bearings oriented at 90 degrees to each other. A carrier rides on two or three sleeve bearings and is driven by X, Y, and Z microstep stepper motors. The X and Y stepper motors are controlled by a joystick, and the Z stepper motor (for focusing) is controlled by a knurled focusing knob, with the joystick and knob mounted on a remote control box. The XYZ locations are indicated in micrometers on a monitor screen.

Electrical movement of the sample with respect to the optical axis of the objective lens 1 can be achieved by controlling the emission timing of the pulse laser 5, so as to have the sample behave as if the sample slides along the rotation direction of the disk 8 to enable scanning of the sample in the peripheral direction of the disk 8. In this case, by intentionally changing the delay time Tb of the delay circuit 17 by the external operating module 100, the observation position of the sample in the sample chamber 81 can slide along the rotation direction of the disk 8. Or by adjusting the operating module 12 to intentionally change the rotation speed of the motor 10, the observation position of the sample can slide similarly. Accordingly, observation of different positions of the sample can be conducted selectively. The above-mentioned function can also be used for compensating the optical axis of the objective lens 1.

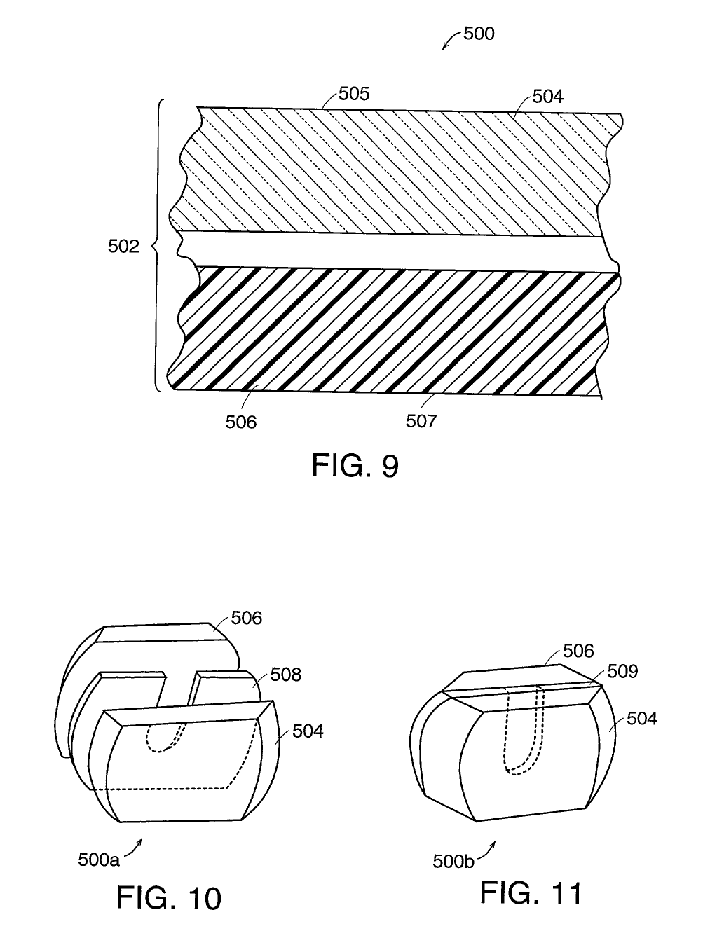

FIG. 9 illustrates a cross-section of a particular specimen chamber 500 that includes a combination 502 of an optical glass window 504 on an objective lens side 505 and an acrylic window 506 (thicker than glass window 504) on a condenser lens side 507.

In a specific implementation, the window combination 502 uses acrylic from commercially available cast acrylic sheets, which tend to demonstrate moderately low, substantially uniform birefringence, of the order of a few nanometers (“nm”) of retardation; rolled acrylic sheets show significantly higher, and often non-uniform, birefringence, and thus are not used in the specific implementation. The order of birefringence of the cast acrylic is reduced to a fraction of a nanometer by annealing the cast acrylic sheets, e.g., on a felt sheet for 120 minutes in a 128 degrees Celsius oven, and cooled at a rate of approximately 0.5 degrees Celsius per minute to ambient temperature. The resulting annealed sheets are cut to an approximate appropriate size for the specimen chamber 500 and then are fabricated to a more final appropriate size and shape using a high-speed diamond tool. The use of the sharp diamond tool helps to prevent the creation of chipped edges which may be introduced by the use of conventional milling and turning tools. If created, such chipped edges may become the foci of undesired stress induced birefringence. (One or more other optically clear plastic materials having low birefringence and an appropriate sign of stress birefringence may be used in place of acrylic.)

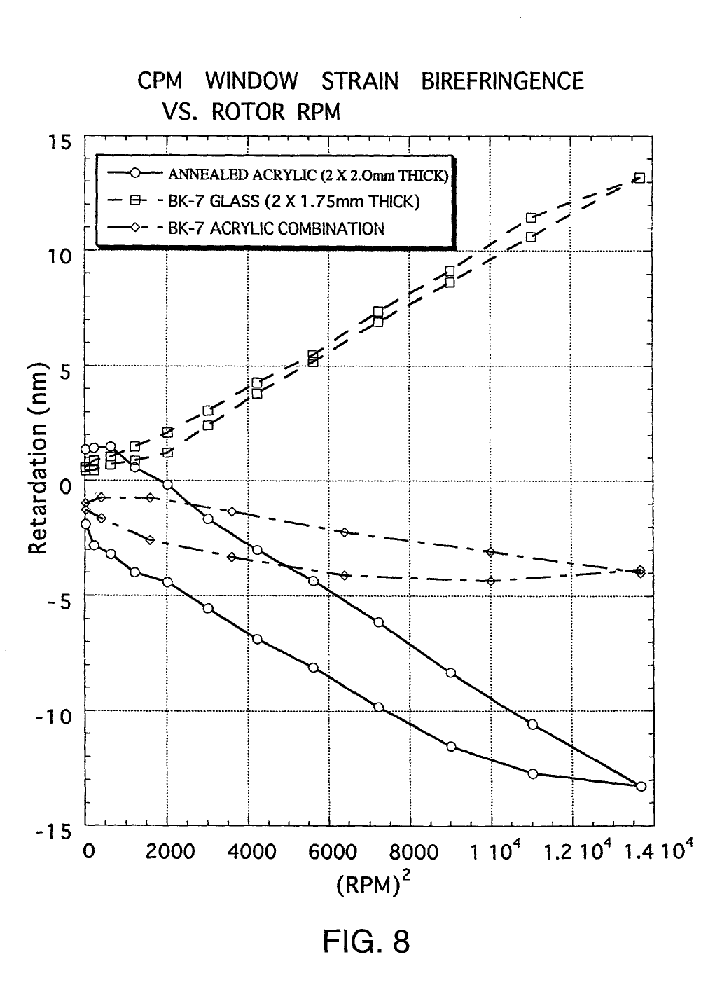

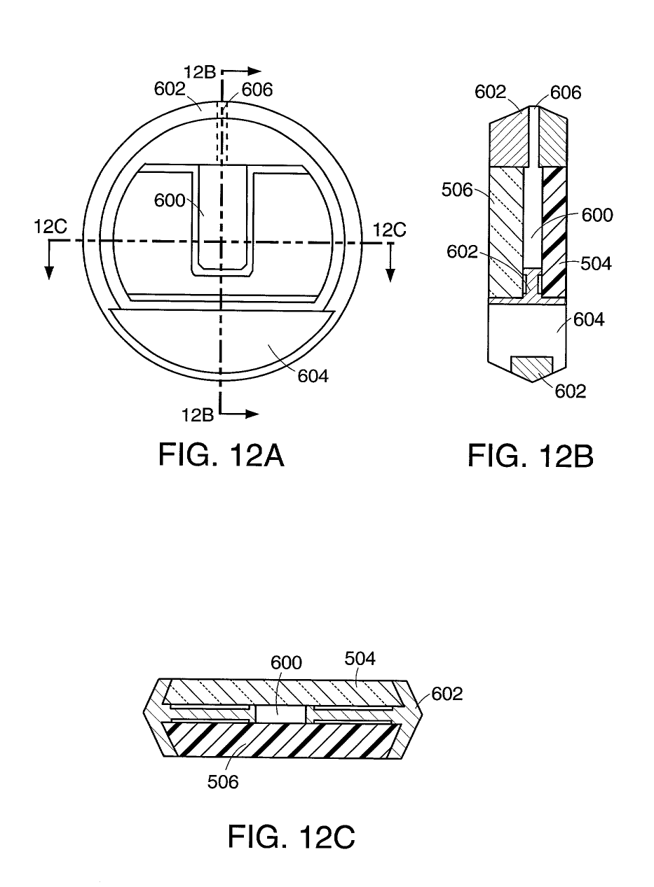

As shown in FIG. 8, described in more detail below, in a case in which specimen chamber 500 containing 10 microliters of water includes a specific combination 502a of a 1.75 mm thick glass window and a 2.0 mm thick annealed acrylic window, the maximum change in window strain birefringence is reduced to approximately 2 nm for rotor speeds of up to 11,700 RPM (corresponding to a force being approximately 11,480 times normal earth gravity), which is approximately an order of magnitude less than the maximum change observed with a conventional window. In the case of combination 502a, strain birefringence is also substantially uniform along the height and width of the water column in the specimen space (indicated by reference numeral 600 in FIGS. 12A-12C). In contrast, in the case of a conventional window, the strain birefringence is substantially non-uniform along the height and width of the water column, and tends to vary by about 5 to 8 nm depending on location in the chamber, with the corresponding axes of birefringence being oriented in a complex, unaligned pattern. With reference to FIGS. 10-11, the window exposed to the centrifuged solution may have a height of approximately 5 to 8 mm and a width of approximately 4 mm. In general, the height depends on the solution that is introduced.

Specimen chamber 500 including the window combination 502 may be constructed in any of multiple ways. For example, in an embodiment 500a (FIG. 10) of the specimen chamber, glass or plastic window plates may be positioned to sandwich one or more self-adhesive silicone rubber sheets 508 (amounting to a thickness of 0.3 to 0.5 mm) having a U-shaped cut out area to hold the specimen-containing fluid, with the window plates clamped together by support rings disposed in a circle surrounding the specimen area. In another example, a specimen chamber embodiment 500b (FIG. 11) has glass or acrylic windows permanently cemented to one or more acrylic spacers 509.

One could use pairs of windows with opposing strain birefringence, or each window itself could be made with laminates of two materials that would be self-compensating.

As described below, at least some configurations of specimen chambers are characterized by strain birefringence of the chamber windows and fluid leakage at higher RPMs.

FIGS. 10-11 illustrate a combination of an optical glass window on the objective lens side and a thicker acrylic window on the condenser lens side, which provides advantages as now described. When 2-mm-thick glass windows were used on both sides, as described above in connection with a different embodiment, the strain birefringence of the windows amounted to more than 20 nm, which exceeded the specimen birefringence as well as the maximum retardation that could be corrected by a Brace-Koehler compensator, even before the referenced maximum RPM was reached. In that case, the sign of strain birefringence was positive, i.e., the vector for the larger refractive index (which was normal to the axis of rotation of the refractive index ellipsoid) lay perpendicular to the direction of compression.

The use of a pair of 2-mm-thick annealed, acrylic plastic windows produced less strain birefringence at the same RPM than was found with the glass windows. The acrylic windows exhibited greater hysteresis than the glass windows, so that the birefringence was more dependent on the sequence of forces to which the windows were exposed. The sign of strain birefringence with the acrylic windows was negative, i.e., the vector for the larger refractive index component (which lay along the axis of rotation of the refractive index ellipsoid) lay parallel to the direction of compression, which was the reverse of the situation with glass.

The exact magnitude and pattern of birefringence in the windows could not be predicted simply from observation of the behavior of single types of windows measured at various RPMs, regardless of the presence or absence of fluids in the chambers. Each window encounters a complex set of forces in the centrifuge, including compression (including against the bottom window support along the radius of the centrifuge by the window's own increased weight) and an outward extension from the hydrostatic head of the fluid contained in the chamber (at 1.0 atm—or 1.0 kg/cm²—per mm head of water column at 10,000 times normal earth gravity). Accordingly, by analysis of the complex forces, it may be possible to further improve the relationship of window strain birefringence to RPM represented by the birefringence versus RPM curve (FIG. 8) beyond the results obtained by the chamber configuration shown in FIGS. 12A-12C.

In at least some cases, it may be advantageous to have, in addition to the appropriate combination of window materials, an appropriately birefringence resistant arrangement for the specimen chamber as a whole. According to some arrangements (see, e.g., FIGS. 10, 11), the glass or plastic windows were sandwiched around one or more self-adhesive silicone sheets, in which a U-shaped area was cut out to hold the specimen-containing fluid, but leaks can result at higher RPMs despite the clamping together of the windows by support rings that were disposed in a circle surrounding the specimen area. In addition, the chamber experienced significant drift as a result of compression of the soft silicone rubber gasket surrounding the chamber. The gasket buffered the windows against localized compression caused by the high centrifugal forces, as well as by clamping of the window cover plates.

It was found that chambers with glass or acrylic windows permanently cemented to acrylic spacers developed strong strain birefringence that was not overcome by annealing. Fabricating integral, all-glass chambers in sufficiently small dimensions with appropriate optical properties was found to be difficult.

FIGS. 12A-12C illustrate an embodiment that includes an assembly with glass and acrylic windows fitted into a stiff silicone gasket 602 (e.g., GE RTV-662 Silicone and Durometer hardness of 68). The gasket was made after degassing the silicone by molding and curing in a Teflon mold. Integral to the gasket is a spacer with compressible narrow ridges around the specimen space and at the peripheral contact areas of the windows. These narrow ridges keep the compressed inner surfaces of the windows parallel to each other while helping to prevent fluid from leaking during several hours of microscope operation at maximum RPM.

The gasket also incorporates a resilient acetyl plastic support mechanism 604 that directly contacts the tapered openings in the aluminum housing of the rotor and chamber cover plate. The support mechanism supports the windows through a thin layer of the gasket material to provide the windows with a substantially uniform cushion while helping to reduce chamber drift.

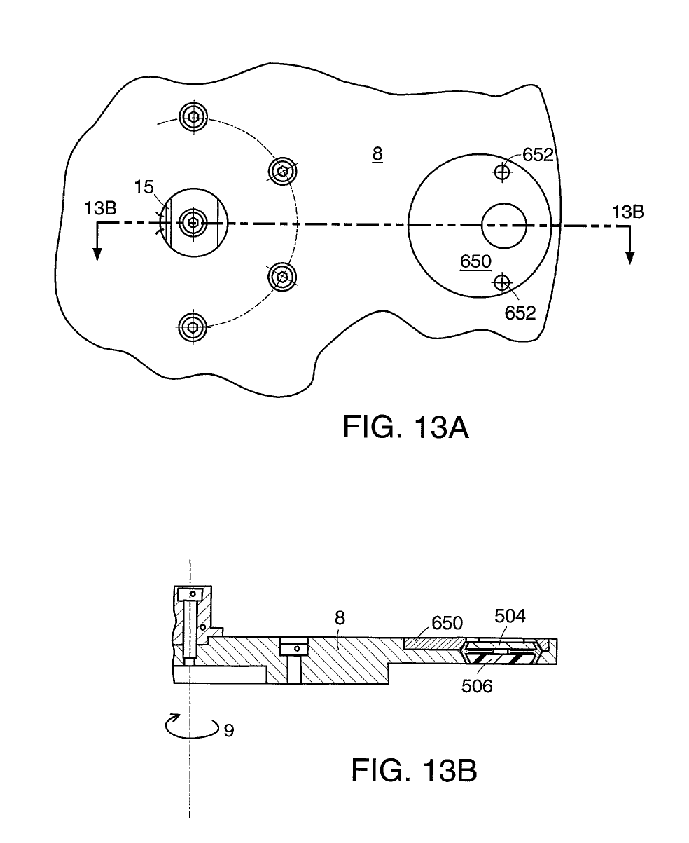

Free-floating cells and their media are injected into the chamber through a port 606 at the top of the silicone gasket. Tissue culture cells growing on small slivers of coverslips are introduced into the chamber during assembly. As shown in FIGS. 13A-13B, the sealing procedure becomes complete when the gasket/window assembly is compressed in the tapered spaces between the rotor 8 and cover plate 650, which is secured by two screws 652 onto a close-fitting recess in the rotor.

In the case of the chamber configuration and the use of the glass-acrylic windows as described in connection with FIG. 9, the birefringence of the windows under actual operating conditions was much subdued as shown in FIG. 8. In a specific case, small offsets of the Brace-Koehler compensator were used, with the glass window on the objective lens side and the correction collar on the objective appropriately adjusted, to achieve specimen images of acceptable quality as described below, at up to an RPM speed of 11,700.

FIG. 8 illustrates a chart showing the results, referenced above, of measurements of the birefringence retardation that develops in windows made from annealed acrylic alone, from BK-7 glass alone, and from a combination of annealed acrylic and BK-7 glass. In the chart, the y-axis indicates retardation in nanometers and the x-axis indicates the square of the rotation speed in rotations per minute. The chart refers to the square of the rotation speed because the centrifugal force developed during rotation is proportional to the square of the rotation speed. (For reference in terms of scale, it is worthwhile to note that the extent of retardation for birefringence that produces interference colors is of the order of a wavelength of light, or greater, i.e., of the order of 500 nanometers or greater.) With reference to the chart, a magnitude of 13-14 nanometers of difference in birefringence is found when the acrylic alone or the glass alone is used, and a magnitude of approximately 2 nanometers of birefringence is found when the combination of acrylic and glass is used. It may be possible to further reduce the birefringence, in an alternative embodiment in which BK-7 glass having a thickness slightly thicker than 1.75 millimeters is used together with acrylic having a thickness of 2.0 millimeters.

As shown in FIG. 8, the combination apparatus develops less than two additional nm of birefringence when the square of the rotation speed is increased from 6000 RPM² and 14,000 RPM². Over the same range of RPM², the all glass apparatus develops at least six additional nm of birefringence, and the all acrylic apparatus develops three or more additional nm of birefringence. Thus, the combination apparatus develops less than two-thirds of the increase in birefringence of the all glass or all acrylic apparatus when the physical force is at least doubled. The increase in birefringence that is developed between 2000 RPM² and 10,000 RPM² is less than four nm for the combination apparatus, is at least seven nm for the all glass apparatus, and is at least seven nm for the all acrylic apparatus. Thus, when the physical force increases at least fivefold, the combination apparatus develops less than 60% of the increase in birefringence that is developed by the all glass apparatus or the all acrylic apparatus.

Other embodiments are within the scope of the following claims. For example, a laminate of glass and acrylic sheets may be used as a cover plate for an optical data disc such as a compact disc or a DVD disc, or as a window of a vehicle. A material other than glass or acrylic may be used that, with respect to stress birefringence, reacts in a way that counters the reaction of the other material in the combination.

What is claimed is:

1. Optical apparatus comprising:
a first material that causes positive birefringent retardation under physical strain; and
a second material that causes negative birefringent retardation under physical strain;
wherein the first and second materials are arranged along a common line of sight so that under physical strain the combination of the first and second materials causes birefringent retardation having a magnitude that is less than the magnitude of the positive retardation caused by the first material and that is less than the magnitude of the negative retardation caused by the second material.

2. The apparatus of claim 1, wherein the first material comprises glass.

3. The apparatus of claim 1, wherein the second material comprises acrylic.

4. The apparatus of claim 1, wherein the first material has a thickness of approximately 1.75 mm.

5. The apparatus of claim 1, wherein the second material has a thickness of approximately 2.0 mm.

6. The apparatus of claim 1, wherein each of the first and second materials has a thickness of approximately 2.0 mm.

7. Specimen viewing apparatus comprising:
a specimen chamber comprising:
a first material that causes positive birefringent retardation under physical strain; and
a second material that causes negative birefringent retardation under physical strain;
wherein the first and second materials are arranged along a common line of sight in the specimen chamber so that under physical strain the combination of the first and second materials causes birefringent retardation having a magnitude that is less than the magnitude of the positive retardation caused by the first material and that is less than the magnitude of the negative retardation caused by the second material.

8. The apparatus of claim 7, wherein the first material comprises glass.

9. The apparatus of claim 7, wherein the second material comprises acrylic.

10. Viewing apparatus comprising:
a window comprising:
a first material that causes positive birefringent retardation under physical strain; and
a second material that causes negative birefringent retardation under physical strain;
wherein the first and second materials are arranged along a common line of sight extending through the window so that under physical strain the combination of the first and second materials causes birefringent retardation having a magnitude that is less than the magnitude of the positive retardation caused by the first material and that is less than the magnitude of the negative retardation caused by the second material.

11. The apparatus of claim 10, wherein the first material comprises glass.

12. The apparatus of claim 10, wherein the second material comprises acrylic.

13. The apparatus of claim 10, wherein the first material has a thickness of approximately 1.75 mm.

14. The apparatus of claim 10, wherein the second material has a thickness of approximately 2.0 mm.

15. The apparatus of claim 10, wherein each of the first and second materials has a thickness of approximately 2.0 mm.

16. A centrifuge microscope comprising:
a rotation axis;
a disk that is mounted on said rotation axis and that is provided with a sample chamber for accommodating a sample, the sample chamber comprising:
a first material that causes positive birefringent retardation under physical strain; and
a second material that causes negative birefringent retardation under physical strain;
wherein the first and second materials are arranged along a common line of sight in the sample chamber so that under physical strain the combination of the first and second materials causes birefringent retardation having a magnitude that is less than the magnitude of the positive retardation caused by the first material and that is less than the magnitude of the negative retardation caused by the second material;
a motor for driving the disk around the rotation axis;
an observation optical system including an objective lens that is positioned such that said sample chamber crosses an optical axis of said objective lens as said disk rotates, and a polarizer and an analyzer that are provided on the optical axis of said objective lens with said sample chamber interposed therebetween;
a pulse laser source for emitting a pulse laser to said sample along the optical axis of said objective lens at a timing at which said sample chamber crosses the optical axis of said objective lens;
an adjuster for adjusting an emission timing of said pulse laser in accordance with a rotational speed of said disk, said adjuster including a counter for determining the rotational speed of said disk, and a delay circuit for delaying the emission timing of said pulse laser in accordance with the rotational speed determined by the counter;
a mirror provided on one of (i) the rotation axis and (ii) the disk, so as to face a given direction; and
a beam emitter for emitting a laser beam to the mirror and for receiving a reflected light from said mirror, so as to output to said delay circuit a pulse corresponding to a given position of said disk.

17. The centrifuge microscope of claim 16, wherein the disk is further provided with a dummy sample chamber spaced apart from the sample chamber.

18. The centrifuge microscope of claim 16, wherein the disk is further provided with another sample chamber that can be viewed by altering the timing of the pulse laser emission upon selectively capturing the beams reflected from appropriately oriented additional timing mirrors that are mounted with different tilt angles relating to the rotational axis of the disk.

19. Optical apparatus comprising:
a first material that causes positive birefringent retardation under physical strain; and
a second material that causes negative birefringent retardation under physical strain;
wherein the first and second materials are arranged along a common line of sight so that under physical strain the combination of the first and second materials causes birefringent retardation of less than 3 nanometers.

20. Optical apparatus comprising:
a first material that causes positive birefringent retardation under physical strain; and
a second material that causes negative birefringent retardation under physical strain;
wherein the first and second materials are arranged along a common line of sight so that under physical strain the combination of the first and second materials causes birefringent retardation of less than a quarter of a wavelength of light.

21. A method of treating acrylic, comprising:
annealing a cast acrylic sheet on a felt sheet in an oven, to produce an annealed sheet;
cutting the annealed sheet to an approximate shape and size, to produce a cut sheet;
using a diamond tool to refine the size and shape of the cut sheet, to produce a finely cut sheet that fits a space provided in a specimen chamber; and
producing, within the specimen chamber, optical apparatus that includes the finely cut sheet;
wherein the finely cut sheet and another material are arranged along a common line of sight so that under physical strain the combination of the finely cut sheet and the other material causes birefringent retardation having a magnitude that is less than the magnitude of the retardation caused by the finely cut sheet alone and that is less than the magnitude of the retardation caused by the other material alone.

22. Optical apparatus comprising:
a first material that causes positive birefringent retardation under physical strain; and
a second material that causes negative birefringent retardation under physical strain;
wherein the first and second materials are arranged along a common line of sight so that doubling the physical strain on the combination of the first and second materials causes increased birefringent retardation having a magnitude that is less than two-thirds of the magnitude of the increased positive retardation caused by the first material and that is less than two-thirds of the magnitude of the increased negative retardation caused by the second material.

23. Optical apparatus comprising:
a first material that causes positive birefringent retardation under physical strain; and
a second material that causes negative birefringent retardation under physical strain;
wherein the first and second materials are arranged along a common line of sight so that increasing the physical strain by at least fivefold on the combination of the first and second materials causes increased birefringent retardation having a magnitude that is less than 60% of the magnitude of the increased positive retardation caused by the first material and that is less than 60% of the magnitude of the increased negative retardation caused by the second material.
